(19) United States
(12) Patent Application Publication
(10) Pub. No.: US 2021/0325671 A1
(43) Pub. Date: Oct. 21, 2021

(54) IMAGE PROJECTION DEVICE AND MOBILE BODY

(71) Applicant: RICOH COMPANY, LTD., Tokyo (JP)

(72) Inventors: Shimpei OGINO, Kanagawa (JP); Kento NAKAMURA, Kanagawa (JP)

(73) Assignee: RICOH COMPANY, LTD., Tokyo (JP)

(21) Appl. No.: 16/981,552

(22) PCT Filed: Mar. 14, 2019
(86) PCT No.: PCT/JP2019/010660

§ 371 Date: Sep. 16, 2020

(30) Foreign Application Priority Data
Mar. 19, 2018 (JP) 2018-051221

(51) Int. Cl. G02B 27/01

(52) U.S. Cl. CPC G02B 27/0101; G02B 2027/0145; G02B 2027/012

(57) ABSTRACT

An image projection device that projects an image formed on an image forming member 15 by a projection optical system 511, in which an image light emitting surface of the image forming member is disposed to be inclined with respect to an optical axis L0 of image light so that when external light L′ incident on the projection optical system is incident on the image light emitting surface of the image forming member, a flux of light traveling along an optical axis of the external light reflected on the image light emitting surface is turned aside from a viewpoint area 402a of a user.

### TECHNICAL FIELD

The present invention relates to an image projection device and a mobile body.

### BACKGROUND ART

Conventionally, an image projection device that projects an image formed on an image forming member by a projection optical system has been known.

For example, Patent Document 1 discloses a head-up display (HUD) device (image projection device) that emits image light emitted from an image light emitting surface of a display device (image forming member) to form an image, such as a liquid crystal display, toward a windshield of a vehicle via a cylindrical lens. In this HUD device, the cylindrical lens is disposed to be inclined with respect to the optical axis of the image light so that when external light (sunlight or the like) incident on the cylindrical lens constituting the projection optical system from the windshield is reflected on the light emitting surface of the cylindrical lens, the reflected external light is turned aside from the viewpoint area (so-called eye range) of the driver (user) of the vehicle.

### SUMMARY OF INVENTION

### Technical Problem

However, external light such as sunlight may be transmitted through the projection optical system including the cylindrical lens to reach the image forming member. In this case, the external light may be reflected on the image light emitting surface of the image forming member, to cause the reflected external light to travel through the optical path of the image light toward the viewing area of the user, and thereby, to reduce the visibility of the image visually recognized by the user.

### Solution to Problem

In order to solve the problem described above, according to an aspect of the present invention, an image projection device projects an image formed on an image forming member by a projection optical system, in which an image light emitting surface of the image forming member is disposed to be inclined with respect to an optical axis of image light so that when external light incident on the projection optical system is incident on the image light emitting surface of the image forming member, a flux of light traveling along an optical axis of the external light reflected on the image light emitting surface is turned aside from a viewpoint area of a user.

### Advantageous Effects of Invention

According to the present invention, it is possible to prevent reduction of the visibility of an image visually recognized by a user due to external light.

### BRIEF DESCRIPTION OF DRAWINGS

FIG. 1 is a schematic diagram illustrating an example of an image display device according to an embodiment;

FIG. 2 is a hardware configuration diagram of an example of the image display device;

FIG. 3 is a functional block diagram of an example of a control device of the image display device;

FIG. 4 is a flowchart of an example of a process relating to the image display device;

FIG. 5 is a plan view of an example of a light deflector of the image display device as viewed in the +Z direction;

FIG. 6 is a cross-sectional view of the light deflector illustrated in FIG. 5 taken along P-P′;

FIG. 7 is a cross-sectional view of the light deflector illustrated in FIG. 5 taken along Q-Q′;

FIG. 8A is a schematic diagram schematically illustrating deformation of a second driver of the light deflector;

FIG. 8B is a schematic diagram schematically illustrating deformation of the second driver of the light deflector;

FIG. 8C is a schematic diagram schematically illustrating deformation of the second driver of the light deflector;

FIG. 9A is a graph illustrating an example of a waveform of a drive voltage A applied to a piezoelectric driver group A of the light deflector;

FIG. 9B is a graph illustrating an example of a waveform of a drive voltage B applied to a piezoelectric driver group B of the light deflector;

FIG. 9C is a graph illustrating an example in which the waveform of the drive voltage in FIG. 9A is superimposed with the waveform of the drive voltage in FIG. 9B;

FIG. 10 is a diagram illustrating optical scanning by the image display device;

FIG. 11 is a schematic diagram of an example of a motor vehicle having a head-up display device installed to which the image display device is applied;

FIG. 12 is a schematic diagram of an example of the head-up display device;

FIG. 13 is an explanatory diagram illustrating an optical path when external light such as sunlight or the like is incident on a screen member from a windshield via a projection minor;

FIG. 14 is an explanatory diagram of an optical path length in which a flux of light traveling along the optical axis of image light emitted from an image light emitting surface of a screen member reaches the center position of an eye range; and

FIG. 15 is a graph illustrating a relationship between the MTF value as an index value of a resolution characteristic and the angle of inclination of the image light emitting surface of the screen member with respect to the optical axis of the image light.

### DESCRIPTION OF EMBODIMENTS

In the following, an embodiment of the present invention will be described. First, an image projection device according to the present embodiment will be described with reference to the drawings.

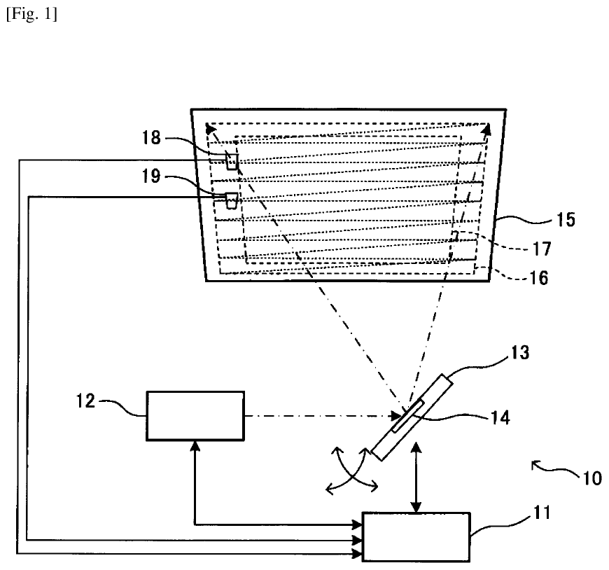

FIG. 1 is a schematic diagram illustrating an example of an image display device provided in an image projection device according to the present embodiment. As illustrated in FIG. 1, the image display device 10 deflects light emitted from a light source device 12 under control of a control device 11 by a reflecting surface 14 of a light deflector 13 as a light scanning member, and optically scans a screen member 15 as an image forming member to form an image (an intermediate image). A scannable area 16, on which the light deflector 13 can perform optical scanning, includes an effective scanning area 17.

The image display device 10 includes the control device 11, the light source device 12, the light deflector 13, a first photodetector 18, and a second photodetector 19.

The control device 11 is an electronic circuit unit including, for example, a CPU (Central Processing Unit) and an FPGA (Field-Programmable Gate Array). The light source device 12 is, for example, a laser device that emits laser light. The light deflector 13 is a MEMS (Micro Electromechanical Systems) device having, for example, the reflecting surface 14 that is movable. The screen member 15 is, for example, a light diffusing member, specifically, a microlens array in which microlenses are arranged two-dimensionally. Note that the screen member 15 may be another type of member such as a light diffusing plate or the like, and does not necessarily need to be a light diffusing member. The first photodetector 18 and the second photodetector 19 are, for example, PDs (Photo Diodes) that receive light and output photodetection signals.

The control device 11 generates control signals for the light source device 12 and the light deflector 13 based on optical scanning information (image information) obtained from an external device or the like, and based on the control signals, outputs drive signals to the light source device 12 and the light deflector 13. Also, based on a signal output from the light source device 12, a signal output from the light deflector 13, a first photodetection signal output from the first photodetector 18, and a second photodetection signal output from the second photodetector 19, the control device 11 synchronizes the light source device 12 and the light deflector 13, and generates control signals.

The light source device 12 emits light from a light source based on a drive signal input from the control device 11.

The light deflector 13 moves the reflecting surface 14 in at least one of a uniaxial direction (one-dimensional direction) and biaxial directions (two-dimensional directions) based on a drive signal input from the control device 11, to deflect the light from the light source device 12. Note that the drive signal is a signal having a predetermined drive frequency. The light deflector 13 has a predetermined natural frequency (also referred to as “resonance frequency”).

This enables, for example, under control of the control device 11 based on the optical scanning information (image information), to reciprocate the reflecting surface 14 of the light deflector 13 in biaxial directions within a predetermined range, so as to deflect the light emitted from the light source device 12 incident on the reflecting surface 14 to perform optical-scanning, and to form (project) an intermediate image on the screen member 15.

Although the image display method in the present embodiment is an optical scanning method that forms an image by optically scanning a screen member, a method may be adopted that uses an image forming member such as a liquid crystal display (LCD) or a fluorescent display tube (VFD).

Note that the light deflector 13 and control by the control device 11 will be described in detail later.

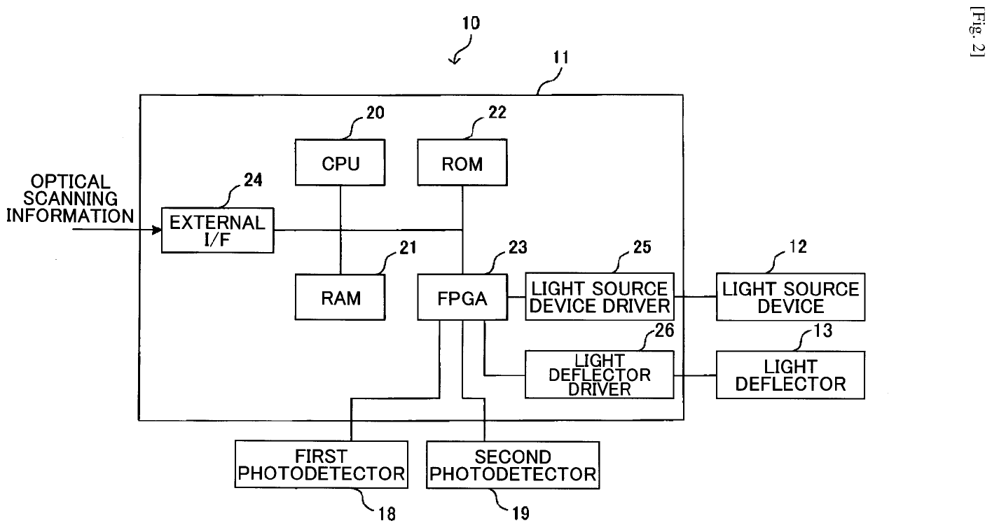

Next, with reference to FIG. 2, a hardware configuration of an example of the image display device 10 will be described. FIG. 2 is a hardware configuration diagram of an example of the image display device 10. As illustrated in FIG. 2, the image display device 10 includes a control device 11, a light source device 12, a light deflector 13, a first photodetector 18, and a second photodetector 19, which are electrically connected with each other. Among these, the control device 11 will be described in detail below.

The control device 11 includes a CPU 20, a RAM (Random Access Memory) 21, a ROM (Read-Only Memory) 22, an FPGA 23, an external I/F 24, a light source device driver 25, and a light deflector driver 26.

The CPU 20 is an arithmetic/logic unit that reads programs and data from a storage device such as the ROM 22 onto the RAM 21, and executes processing, to implement overall control and functions of the control device 11. The RAM 21 is a volatile storage device that temporarily holds programs and data.

The ROM 22 is a nonvolatile storage device capable of holding programs and data even when the power is turned off, and stores a processing program and data executed by the CPU 20 to control functions of the image display device 10.

The FPGA 23 is a circuit that outputs control signals suitable for the light source device driver 25 and the light deflector driver 26 according to a process executed by the CPU 20. Also, the FPGA 23 obtains output signals of the light source device 12 and the light deflector 13 via the light source device driver 25 and the light deflector driver 26, respectively, and further obtains photodetection signals from the first photodetector 18 and the second photodetector 19, to generate a control signal based on the output signals and the photodetection signals.

The external I/F 24 is an interface with, for example, an external device and/or a network. The external device includes, for example, a host device such as a PC (Personal Computer), and a storage device such as a USB memory, an SD card, a CD, a DVD, an HDD, and an SSD. Also, the network is, for example, a CAN (Controller Area Network) or a LAN (Local Area Network) in a motor vehicle, an inter-vehicle communication, the Internet, or the like. The external I/F 24 simply needs to be configured to be capable of connecting or communicating with an external device, and an external I/F 24 may be provided for each external device.

The light source device driver 25 is an electric circuit that outputs a drive signal representing a drive voltage or the like to the light source device 12 according to an input control signal.

The light deflector driver 26 is an electric circuit that outputs a drive signal representing a drive voltage or the like to the light deflector 13 according to an input control signal.

In the control device 11, the CPU 20 obtains optical scanning information from an external device or a network via the external I/F 24. Note that the CPU 20 simply needs to be configured to be capable of obtaining optical scanning information; the ROM 22 or the FPGA 23 in the control device 11 may be configured to store the optical scanning information, or a storage device such as an SSD may be newly provided in the control device 11 and configured to store the optical scanning information.

Here, the optical scanning information is information representing how the light source device 12 and the light deflector 13 optically scan the screen member 15, and more specifically, for example, image data in the case of displaying an intermediate image by optical scanning.

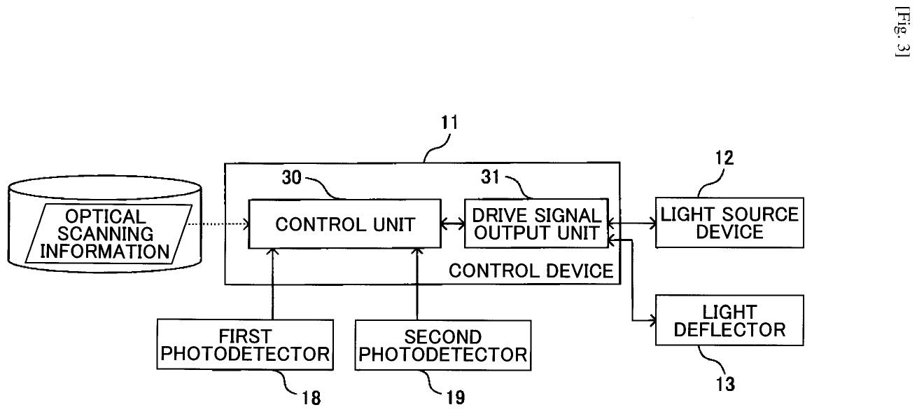

Next, with reference to FIG. 3, a functional configuration of the control device 11 of the image display device 10 will be described. FIG. 3 is a functional block diagram of an example of the control device 11 of the image display device 10. The control device 11 according to the present embodiment can implement the functional units described below according to instructions of the CPU 20 and the hardware configuration illustrated in FIG. 2.

As illustrated in FIG. 3, the control device 11 includes a control unit 30 and a drive signal output unit 31 as functional units. The control unit 30 is a control means implemented by, for example, the CPU 20, the FPGA 23, and the like that obtains optical scanning information and signals from the devices, to generate control signals based on these so as to output the control signals to the drive signal output unit 31.

For example, the control unit 30 obtains image data as optical scanning information from an external device or the like, to generate control signals from the image data by a predetermined process so as to output the control signals to the drive signal output unit 31. Also, the control unit 30 obtains output signals of the light source device 12 and the light deflector 13 via the drive signal output unit 31, to generate a control signal based on the output signals. Further, the control unit 30 obtains photodetection signals of the first photodetector 18 and the second photodetector 19, respectively, to generate a control signal based on the photodetection signals.

The drive signal output unit 31 is implemented by the light source device driver 25, the light deflector driver 26, and the like, to output a drive signal to the light source device 12 or the light deflector 13 based on the input control signal. The drive signal output unit 31 functions, for example, as a means for applying a drive voltage to the light source device 12 or the light deflector 13. The drive signal output unit 31 may be provided for each object to which a drive signal is output.

The drive signal is a signal for controlling drive of the light source device 12 or the light deflector 13. For example, in the light source device 12, the drive signal represents a drive voltage for controlling the emission timing and emission intensity of the light source. Also, for example, in the light deflector 13, the drive signal represents a drive voltage for controlling the timing and movable range when moving the reflecting surface 14 of the light deflector 13.

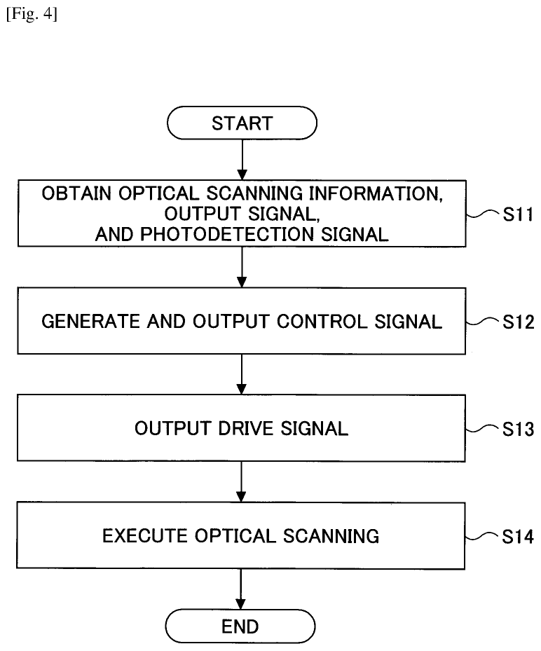

Next, with reference to FIG. 4, a process executed by the image display device 10 to optically scan the screen member 15 will be described. FIG. 4 is a flowchart of an example of the process relating to the image display device 10. At Step S11, the control unit 30 obtains optical scanning information from an external device or the like. Also, the control unit 30 obtains output signals of the light source device 12 and the light deflector 13, respectively, via the drive signal output unit 31, and obtains photodetection signals of the first photodetector 18 and the second photodetector 19, respectively.

At Step S12, the control unit 30 generates a control signal from the obtained optical scanning information, output signals, and photodetection signals, to output a control signal to the drive signal output unit 31. At this time, since there may be a case where the output signals and photodetection signals cannot be obtained when being activated, a predetermined operation may be performed as a separate step when being activated.

At Step S13, the drive signal output unit 31 outputs drive signals to the light source device 12 and the light deflector 13 based on the input control signals.

At Step S14, the light source device 12 emits light based on the input drive signal. Also, the light deflector 13 moves the reflecting surface 14 based on the input drive signal. By driving the light source device 12 and the light deflector 13, light is deflected in an appropriate direction, to perform optical scanning.

Note that in the image display device 10 of the present embodiment, although the control device 11 functions as a single device for controlling the light source device 12 and the light deflector 13, it is also possible to separate a control device for a light source device from a control device for a light deflector.

Also, in the image display device 10 of the present embodiment, the single control device 11 is provided with the functions of the control unit 30 of the light source device 12 and the light deflector 13, and the function of the drive signal output unit 31; however, these functions may be provided in separate devices, for example, a drive signal output device having a drive signal output unit 31 may be provided separately from the control device 11 having the control unit 30.

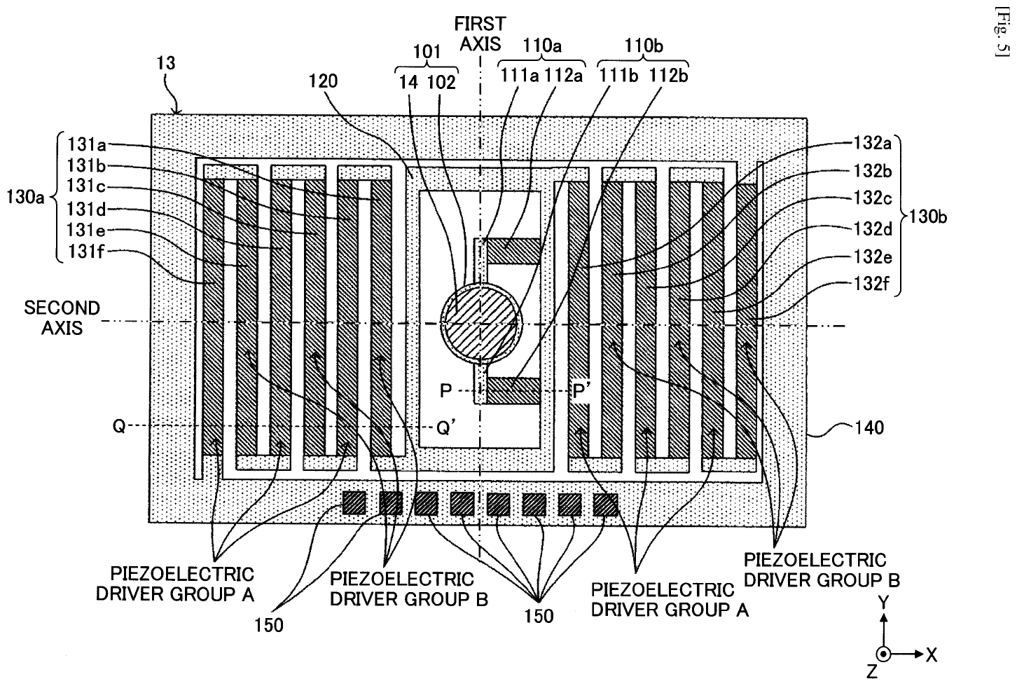

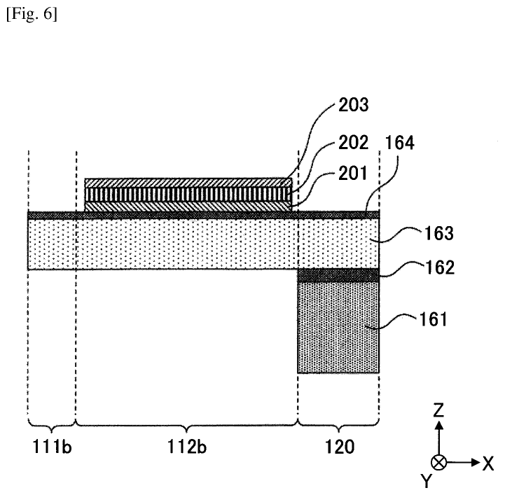

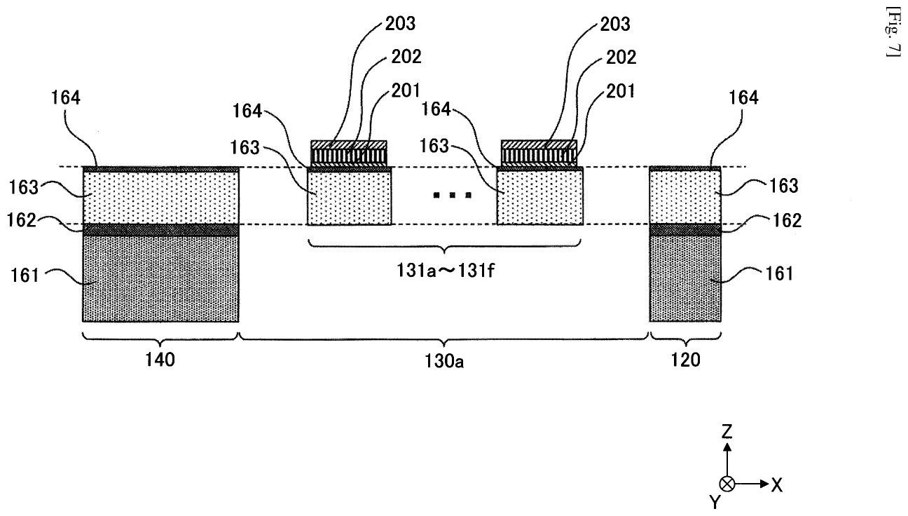

Next, with reference to FIGS. 5 to 7, the light deflector 13 will be described in detail. FIG. 5 is a plan view of a double-supported light deflector capable of deflecting light in biaxial directions. FIG. 6 is a cross-sectional view taken along a line PP′ in FIG. 5. FIG. 7 is a cross-sectional view taken along a line QQ′ in FIG. 5.

As illustrated in FIG. 5, the light deflector 13 includes a minor part 101 for reflecting incident light; first drivers 110a and 110b connected to the minor part and driving the mirror part around a first axis parallel to the Y axis; a first supporting member 120 that supports the mirror part and the first drivers; second drivers 130a and 130b connected to the first supporting members and driving the mirror part and the first supporting members around a second axis parallel to the X axis; a second supporting member 140 for supporting the second drivers; and electrode connection parts 150 electrically connected with the first drivers, the second drivers, and the control device.

The light deflector 13 has, for example, a reflecting surface 14, first piezoelectric drivers 112a and 112b, second piezoelectric drivers 131a to 131f, 132a to 132f, electrode connection parts 150, and the like formed on a single SOI (Silicon On Insulator) substrate, which is then shaped by etching or the like, so as to have these elements integrally formed. Note that the formation of these elements may be performed after shaping the SOI substrate or while shaping the SOI substrate.

The SOI substrate is a substrate that has a silicon oxide layer 162 provided on a first silicon layer made of single crystal silicon (Si), and further has a second silicon layer made of single crystal silicon provided on the silicon oxide layer 162. In the following, the first silicon layer is referred to as the silicon support layer 161, and the second silicon layer is referred to as the silicon active layer 163. Note that the SOI substrate is used after sintering to form a silicon oxide layer 164 on the surface of the silicon active layer 163.

Since the thickness of the silicon active layer 163 in the Z axis direction is smaller than those in the X-axis direction or the Y-axis direction, a member constituted with the silicon active layer 163, or the silicon active layer 163 and the silicon oxide layer 164 has a function as an elastic part having elasticity. Note that in the present embodiment, although the silicon oxide layer 164 is provided to prevent electrical contact between the silicon active layer 163 and the lower electrode 201, the silicon oxide layer 164 may be replaced with another insulative material.

Note that the SOI substrate does not necessarily need to have a planar shape, and may have a curvature or the like. Also, as long as being a substrate that can be integrally shaped by etching or the like and can partially have elasticity, the member used for forming the light deflector 13 is not limited to the SOI substrate.

The minor part 101 is constituted with, for example, a circular minor part base 102 and the reflection surface 14 formed on the +Z side surface of the minor part base. The mirror part base 102 is constituted with, for example, the silicon active layer 163 and the silicon oxide layer 164.

The reflecting surface 14 is formed of a metallic thin film containing, for example, aluminum, gold, silver, or the like. Also, the minor part 101 may have ribs for reinforcing the mirror part formed on the −Z side surface of the minor part base 102.

The ribs are constituted with, for example, the silicon support layer 161 and the silicon oxide layer 162, so as to be capable of preventing distortion of the reflecting surface 14 caused by movement.

Each of the first drivers 110a and 110b is constituted with a torsion bar 111a or 111b having one end connected to the minor part base 102 and extending in the first axis direction to support the mirror part 101 to be movable; and a first piezoelectric driver 112a or 112b having one end connected to the torsion bar and the other end connected to the inner peripheral part of the first supporting member 120.

As illustrated in FIG. 6, the torsion bars 111a and 111b are constituted with the silicon active layer 163 and the silicon oxide layer 164. The first piezoelectric drivers 112a and 112b are formed by forming a lower electrode 201, a piezoelectric part 202, and an upper electrode 203, in this order, on the +Z side surface of the silicon active layer 163 and the silicon oxide layer 164 as the elastic part.

The upper electrode 203 and the lower electrode 201 are formed of, for example, gold (Au) or platinum (Pt). The piezoelectric part 202 is formed of, for example, PZT (lead zirconate titanate) as a piezoelectric material.

Referring back to FIG. 5, the first supporting member 120 is constituted with, for example, the silicon support layer 161, the silicon oxide layer 162, the silicon active layer 163, and the silicon oxide layer 164, which is a rectangular supporting member formed to enclose the minor part 101.

The second drivers 130a and 130b are constituted with, for example, the multiple second piezoelectric drivers 131a to 131f and 132a to 132f, which are connected as if being folded up to be adjacent to one another, and one end of each of the second drivers 130a and 130b is connected to the outer peripheral part of the first supporting member 120, and the other end is connected to the inner peripheral part of the second supporting member 140. Such a serpentine structure is called a meandering structure. Also, as in the case of the second piezoelectric driver, a structure that is constituted with one beam and a member having a driving force is called a driving cantilever.

At this time, the connecting part between the second driver 130a and the first supporting member 120, and the connecting part between the second driver 130b and the first supporting member 120 are point symmetric with respect to the center of the reflecting surface 14; further, the connecting part between the second driver 130a and the second supporting member 140, and the connecting part between the second driver 130b and the second supporting member 140 are also point symmetric with respect to the center of the reflecting surface 14.

As illustrated in FIG. 7, the second drivers 130a and 130b are formed by forming the lower electrode 201, the piezoelectric part 202, and the upper electrode 203, in this order, on the +Z side surface of the silicon active layer 163 and the silicon oxide layer 164 as the elastic part. The upper electrode 203 and the lower electrode 201 are formed of, for example, gold (Au) or platinum (Pt). The piezoelectric part 202 is formed of, for example, PZT (lead zirconate titanate) as a piezoelectric material.

Referring back to FIG. 5, the second supporting member 140 is constituted with, for example, the silicon support layer 161, the silicon oxide layer 162, the silicon active layer 163, and the silicon oxide layer 164, which is a rectangular supporting member formed to enclose the minor part 101, the first drivers 110a and 110b, the first supporting member 120, and the second drivers 130a and 130b.

The electrode connection parts 150 are formed, for example, on the +Z side surface of the second supporting member 140, and are electrically connected with the upper electrodes 203 and the lower electrodes 201 of the first piezoelectric drivers 112a and 112b, the second piezoelectric drivers 131a to 131f, and the control device 11 via electrode wiring of aluminum (Al) or the like.

Note that in the present embodiment, although the case has been described as an example where the piezoelectric part 202 is formed only on one surface (the surface on the +Z side) of the silicon active layer 163 and the silicon oxide layer 164 as the elastic part, the piezoelectric part 202 may be provided on the other surface (e.g., the surface on the −Z side) of the elastic part, or both on the one surface and on the other surface of the elastic part.

Also, as long as being capable of driving the mirror part 101 around the first axis or around the second axis, the shapes of the elements are not limited to the shapes as in the present embodiment. For example, the torsion bars 111a and 111b and the first piezoelectric drivers 112a and 112b may have shapes having a curvature.

Also, at least one of on the +Z side surface of the upper electrodes 203 of the first drivers 110a and 110b, on the +Z side surface of the first supporting member 120, on the +Z side surface of the upper electrodes 203 of the second drivers 130a and 130b, and on the +Z side surface of the second supporting member 140, an insulating layer may be formed of a silicon oxide film. At this time, by providing electrode wiring on the insulating layer, and partially removing or not forming the insulating layer as an opening at a connection spot where the upper electrode 203 or the lower electrode 201 is connected with the electrode wiring, it is possible to increase the degree of freedom in designing the first drivers 110a and 110b, the second drivers 130a and 130b, and the electrode wiring, and further, to prevent a short circuit due to the electrodes contacting each other. Note that the insulating layer simply needs to be an insulative member, or may be provided with a function as an antireflection material when formed as a thin film.

Next, control executed by the control device 11 to drive the first drivers 110 and the second drivers 130 of the light deflector 13 will be described in detail. When a positive or negative voltage is applied in a polarization direction, the piezoelectric parts 202 of the first drivers 110a and 110b and the second drivers 130a and 130b are deformed (e.g., expanded or contracted) in proportion to the potential of the applied voltage, to exhibit the so-called inverse piezoelectric effect. The first drivers 110a and 110b and the second drivers 130a and 130b move the mirror part 101 by using the inverse piezoelectric effect. At this time, an angle by which a flux of light incident on the reflecting surface 14 of the mirror part 101 is deflected is referred to as a deflection angle. The deflection angle represents a degree of deflection by the light deflector 13. Here, the deflection angle when the voltage is not applied to the piezoelectric part 202 is defined as zero, a deflection angle greater than the zero angle is defined as a positive deflection angle, and a deflection angle smaller than the zero angle is defined as a negative deflection angle.

First, control executed by the control device 11 for driving the first drivers 110a and 110b will be described. In the first drivers 110a and 110b, when a drive voltage is applied in parallel to the piezoelectric parts 202 of the first piezoelectric drivers 112a and 112b via the upper electrode 203 and the lower electrode 201, each of the respective piezoelectric parts 202 is deformed. This deformation of the piezoelectric parts 202 has an effect of bending and deforming the first piezoelectric drivers 112a and 112b.

As a result, a driving force around the first axis acts on the minor part 101 via the torsion of the two torsion bars 111a and 111b, which moves the mirror part 101 around the first axis. The drive voltage applied to the first drivers 110a and 110b is controlled by the control device 11.

At this time, by applying the drive voltage having a predetermined waveform to the first piezoelectric drivers 112a and 112b of the first drivers 110a and 110b in parallel, the control unit 11 can move the minor part 101 around the first axis in cycles of the drive voltage having a predetermined sinusoidal waveform. Also, for example, when the frequency of the predetermined waveform voltage is set to approximately 20 kHz, which is virtually the same as the resonance frequency of the torsion bars 111a and 111b, by using an occurrence of the resonance caused by the torsion of the torsion bars 111a and 111b, it is possible to resonantly oscillate the minor part 101 at approximately 20 kHz.

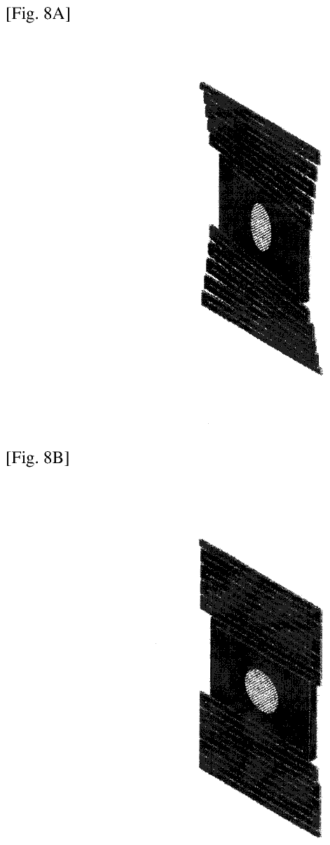

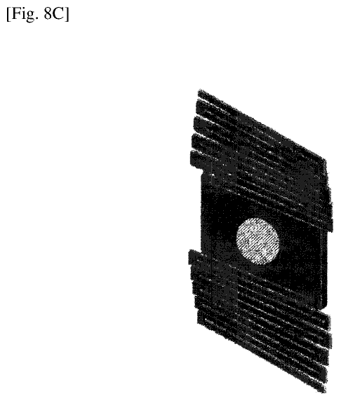

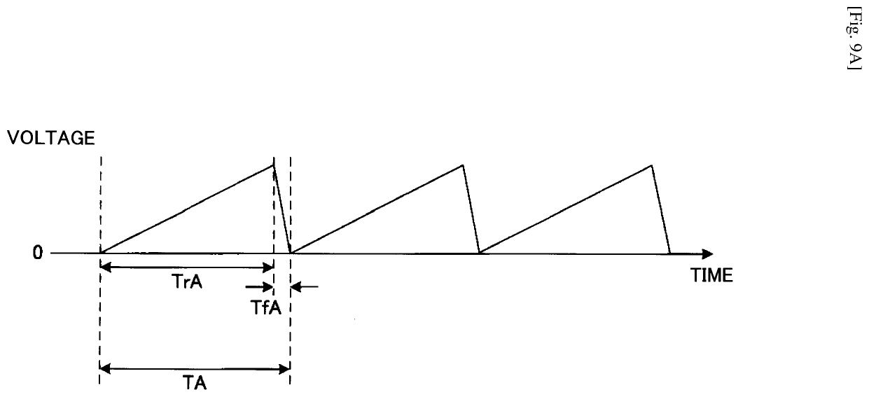

Next, with reference to FIGS. 8A-8C, control executed by the control device for driving the second drivers 130 will be described. FIGS. 8A-8C are schematic diagrams schematically illustrating driving of the second drivers 130a and 130b of the light deflector 13. An area drawn with slanting lines represents the mirror part 101 and the like.

Among the multiple second piezoelectric drivers 131a to 131f of the second driver 130a, even-numbered second piezoelectric drivers counted from the second piezoelectric driver 131a closest to the minor part, namely, the second piezoelectric drivers 131b, 131d, and 131f are classified as a piezoelectric driver group A (also referred to as the “first actuator”).

Also, among the multiple second piezoelectric drivers 132a to 132f of the second driver 130b, odd-numbered second piezoelectric drivers counted from the second piezoelectric driver 132a closest to the mirror part, namely, the second piezoelectric drivers 132a, 132c, and 132e are similarly classified as the piezoelectric driver group A. When the drive voltage is applied in parallel, as illustrated in FIG. 8A, the piezoelectric driver group A is bent and deformed in the same direction, and the mirror part 101 is moved around the second axis to have a positive deflection angle.

Also, among the multiple second piezoelectric drivers 131a to 131f of the second driver 130a, odd-numbered second piezoelectric drivers counted from the second piezoelectric driver 131a closest to the mirror part, namely, the second piezoelectric drivers 131a, 131c, and 131e are classified as a piezoelectric driver group B (also referred to as the “second actuator”).

Also, among the multiple second piezoelectric drivers 132a to 132f of the second driver 130b, even-numbered second piezoelectric drivers counted from the second piezoelectric driver 132a closest to the mirror part, namely, the second piezoelectric drivers 132b, 132d, and 132f are similarly classified as the piezoelectric driver group B. When the drive voltage is applied in parallel, as illustrated in FIG. 8C, in the piezoelectric driver group B, the mirror driver group B is bent and deformed in the same direction, and the minor part 101 is moved around the second axis to have a negative deflection angle.

Also, as illustrated in FIG. 8B, the deflection angle becomes zero when the voltage is not applied, or when the amount of movement of the mirror part 101 by the piezoelectric driver group A caused by a voltage application is balanced with the amount of movement of the mirror part 101 by the piezoelectric driving group B caused by the voltage application.

As illustrated in FIGS. 8A and 8C, in the second drivers 130a and 130b, by bending and deforming the multiple piezoelectric parts 202 of the piezoelectric driver group A or the multiple piezoelectric parts 202 of the piezoelectric driver group B, the amount of movement caused by the bending deformation can be accumulated to increase the deflection angle around the second axis of the mirror part 101. Also, by applying the drive voltage to the second piezoelectric drivers so as to continuously repeat the states of FIGS. 8A to 8C, it is possible to drive the mirror part 101 around the second axis.

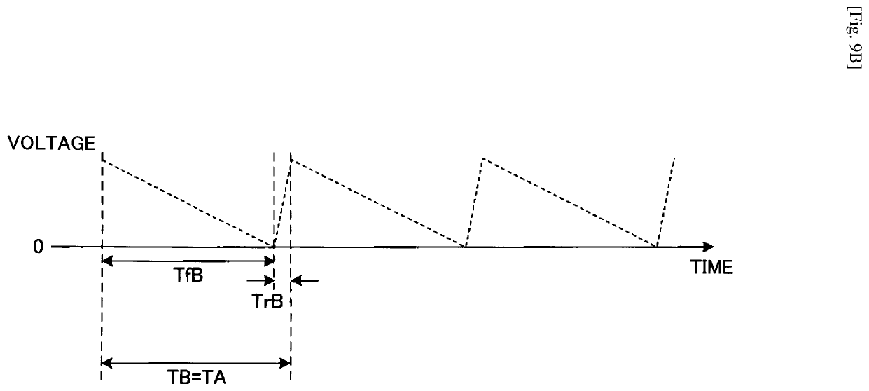

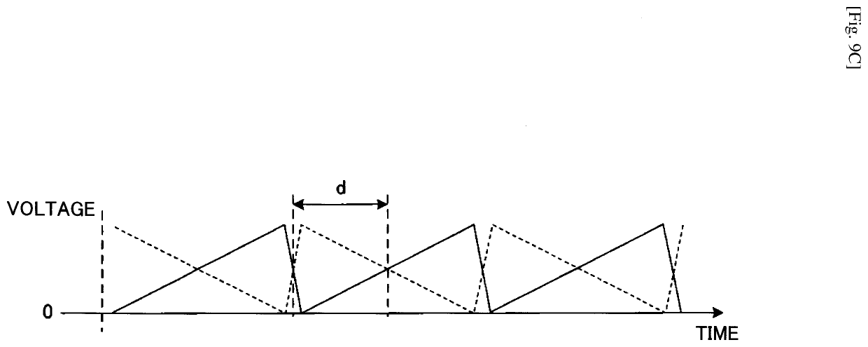

The drive signal (drive voltage) applied to the second drivers 130a and 130b is controlled by the control device 11. With reference to FIG. 9, the drive voltage applied to the piezoelectric driver group A (referred to as the “drive voltage A”, below) and the drive voltage applied to the piezoelectric driver group B (referred to as the “drive voltage B”, below) will be described. Also, an application means for applying the drive voltage A (a first drive voltage) will be referred to as a “first application means”, and an application means for applying the drive voltage B (a second drive voltage) will be referred to as a “second application means”.

FIG. 9A is an example of a waveform of the drive voltage A applied to the piezoelectric driver group A of the light deflector 13. FIG. 9B is an example of a waveform of the drive voltage B applied to the piezoelectric driver group B of the light deflector 13. FIG. 9C is a diagram in which the waveform of the drive voltage A is superimposed with the waveform of the drive voltage B.

As illustrated in FIG. 9A, the waveform of the drive voltage A applied to the piezoelectric driver group A is, for example, a saw-toothed waveform, and the frequency is, for example, 60 Hz. Also, the waveform of the drive voltage A is set in advance to have a ratio of time periods represented as, for example, TrA:TfA=8.5:1.5 where TrA represents a time width of a rising period in which the voltage value increases from a minimal value to the next maximal value, and TfA represents a time width of a falling period during which the voltage value decreases from the maximal value to the next minimal value. At this time, the ratio of TrA to one cycle is referred to as the symmetry of the drive voltage A.

As illustrated in FIG. 9B, the waveform of the drive voltage B applied to the piezoelectric driver group B is, for example, a saw-toothed waveform and the frequency is, for example, 60 Hz. Also, the waveform of the drive voltage B is set in advance to have a ratio of time periods represented as, for example, TrB:TfB=8.5:1.5 where TrB represents a time width of a rising period in which the voltage value increases from a minimal value to the next maximal value, and TfB represents a time width of a falling period during which the voltage value decreases from the maximal value to the next minimal value. At this time, the ratio of TfB to one cycle is referred to as the symmetry of the drive voltage B.

Also, as illustrated in FIG. 9C, for example, the cycle TA of the waveform of the drive voltage A is set to be the same as the cycle TB of the waveform of the drive voltage B. At this time, the drive voltage A and the drive voltage B have a phase difference d.

Note that the saw-toothed waveforms of the drive voltage A and the drive voltage B are generated, for example, by superimposing sinusoidal waves. Also, it is desirable that the frequency (drive frequency fs) of the drive voltage A and the drive voltage B is a half-integer multiple of the lowest order natural frequency f(1) of the light deflector 13. For example, it is desirable to set fs to 1/5.5 times, 1/6.5 times, 1/7.5 times of f(1). Setting to a half-integer multiple enables to prevent oscillations due to harmonics of the drive frequency. Such oscillations that adversely affect optical scanning are referred to as unnecessary oscillations.

Also, in the present embodiment, although a drive voltage having a saw-toothed waveform is used as the drive voltages A and B, the waveform is not limited as such; it is also possible to change the waveform in accordance with the device characteristics of the light deflector, such that the drive voltage may have a waveform obtained by rounding the peaks of a saw-toothed waveform, or a waveform in which the linear region in a saw-toothed waveform is curved. In this case, the symmetry is the ratio of the rise time to one cycle or the ratio of the fall time to one cycle. At this time, which of the rise time and the fall time is used as a reference may be set discretionarily.

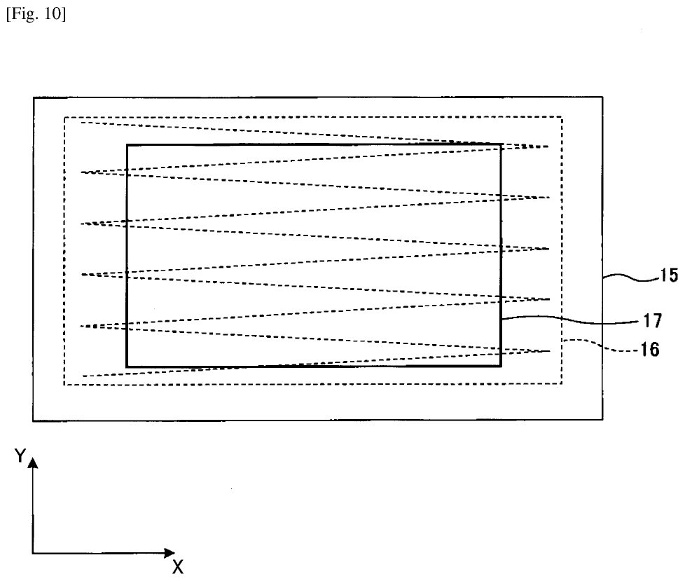

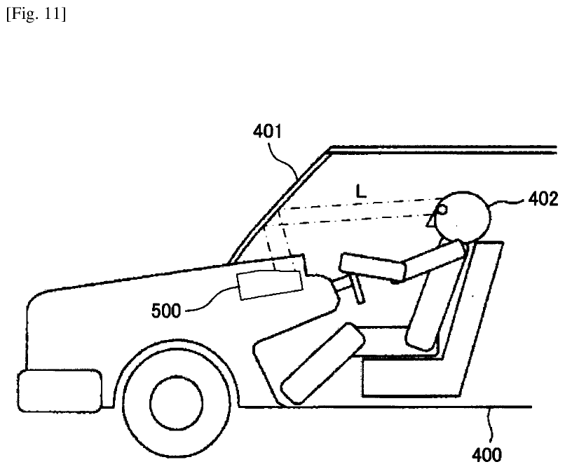

With reference to FIG. 10, an optical scanning method executed by the image display device 10 will be described. FIG. 10 is a diagram illustrating optical scanning executed by the image display device 10. The image display device 10 deflects light from the light source device 12 in two directions by the light deflector 13, to optically scan the scannable area 16 including the effective scanning area 17 on the screen member 15 as illustrated in FIG. 10. As described above, the image display device 10 optically scans the reflecting surface of the light deflector 13 in one direction among the two directions (referred to as the “X-axis direction”, below) by high-speed driving caused by resonance by the sinusoidal wave drive signal; and optically scans the reflecting surface of the light deflector 13 in the other direction (referred to as the “Y-axis direction”, below) by low-speed driving caused by non-resonance by the saw-toothed wave drive signal. Such a driving method of performing optical scanning in a zigzag manner in two directions is also called a raster scanning method.

In the driving method, it is desirable that optical scanning can be performed with a constant speed in the Y-axis direction in the effective scanning area 17. This is because if the scanning speed in the Y-axis direction is not constant, for example, when image projection is performed by optical scanning, uneven brightness, fluctuation, and the like occur in the projected image, which impairs the projected image. To make the scanning speed in the Y-axis direction constant, it is necessary to keep the moving speed of the reflecting surface 14 of the light deflector 13 around the second axis, namely, the change in time of the deflection angle around the second axis of the reflecting surface 14 in the effective scanning area 17, constant.

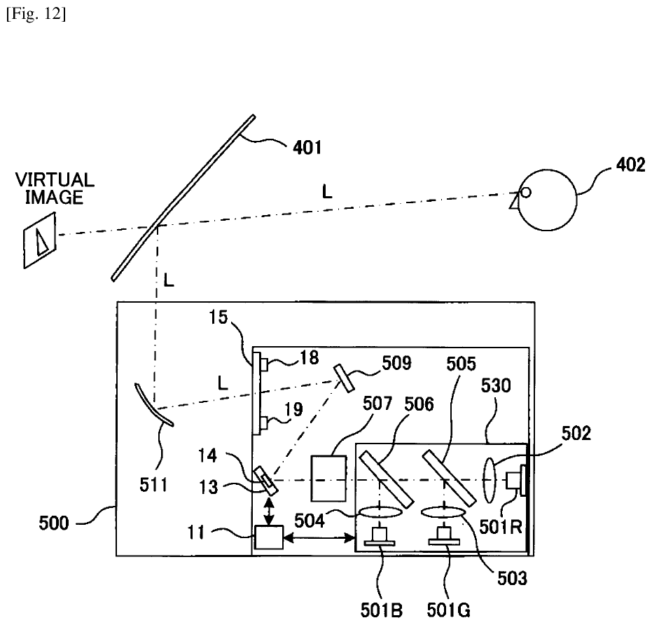

Next, with reference to FIG. 11 and FIG. 12, the image display device 10 of the present embodiment will be described, and an image projection device to which this image display device 10 is applied will be described in detail. FIG. 11 is a schematic diagram related to an embodiment of a motor vehicle 400, which is a vehicle as a mobile body having a head-up display device 500 as an example of an image projection device installed. FIG. 12 is a schematic view of an example of the head-up display device 500.

As illustrated in FIG. 11, the head-up display device 500 is installed, for example, close to a windshield 401 or the like of the motor vehicle 400. Projected light (image light) L emitted from the head-up display device 500 is reflected on the windshield 401 and travels toward the observer (driver 402) as the user. This enables the driver 402 to visually recognize an image projected by the head-up display device 500 as a virtual image. Note that a combiner may be installed on the inner wall surface of the windshield so as to cause the user to visually recognize a virtual image with the image light reflected on the combiner.

As illustrated in FIG. 12, the head-up display device 500 emits laser light of red, green, and blue from laser light sources 501R, 501G, and 501B. The emitted laser light is transmitted through an incident optical system including collimator lenses 502, 503, and 504 provided for the respective laser light sources, two dichroic mirrors 505 and 506, and a light amount adjuster 507, and then, is deflected by the light deflector 13 having the reflecting surface 14. Then, the deflected laser is focused on the screen member 15 via a plane minor 509 to form an intermediate image. The laser light forming the intermediate image is transmitted through the screen member 15, to be projected by the projection optical system constituted with the projection mirror 511. The screen member 15 is provided with the first photodetector 18 and the second photodetector 19, to adjust the image display device 10 by using the respective photodetection signals.

In the head-up display device 500, the laser light sources 501R, 501G, and 501B; the collimator lenses 502, 503, and 504; and the dichroic mirrors 505 and 506 constitute a light source unit 530 as a unit included in an optical housing.

The image display device according to the present embodiment is constituted with the light source unit 530, the light deflector 13, the control device 11, the plane mirror 509, and the screen member 15.

The head-up display device 500 projects an intermediate image displayed on the screen member 15 onto the windshield 401 of the motor vehicle 400 so as to cause the driver 402 to visually recognize the intermediate image as a virtual image.

The laser light beams of respective colors emitted from the laser light sources 501R, 501G, and 501B are made substantially parallel light beams by the collimator lenses 502, 503, and 504, respectively, to be synthesized by the two dichroic minors 505 and 506. The synthesized laser light is adjusted with respect to the amount of light by the light amount adjuster 507, and then, two-dimensionally scanned by the light deflector 13 having the reflecting surface 14. The projection light (image light) L two-dimensionally scanned by the light deflector 13 is reflected on the plane minor 509, and then, collected on the screen member 15 to form an intermediate image.

The screen member 15 has a configuration in which a microlens array having two-dimensionally arranged microlenses is provided on the image light emitting surface (the left side surface in FIG. 12), to diverge and enlarge the image light L incident on the image light incident surface (the right side surface in FIG. 12) of the screen member 15 by units of microlenses.

The light deflector 13 causes the reflection surface 14 to reciprocate in biaxial directions, to two-dimensionally scan the projection light L incident on the reflection surface 14. The drive control of the light deflector 13 is performed in synchronization with the light emission timing of the laser light sources 501R, 501G, and 501B.

As above, the head-up display device 500 as an example of the image projection device has been described; note that the image projection device simply needs to be a device that projects an image formed on an image forming member by a projection optical system. For example, it can be similarly applied to a projector that projects an image on a display screen; a head mount display device that is mounted on an attachment member to be attached on the head or the like of the observer, with which an image is projected onto the reflective/transmissive screen of the attachment member, or into the eyeball as a screen.

Also, the image projection device can be installed not only on a vehicle or an attachment member, but also on an mobile objects such as aircraft, ship, mobile robot, or the like, or a non-mobile object such as a work robot that operates on an object to be driven, such as a manipulator, without moving away from the place where it is installed.

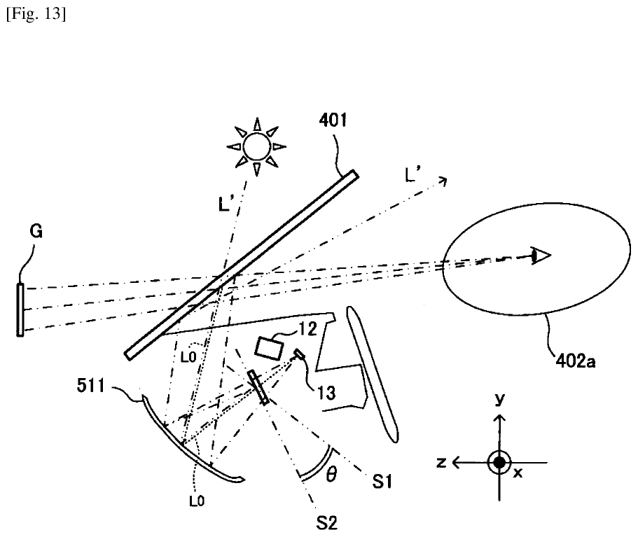

Next, the disposition of the screen member 15, which is a characteristic part of the present invention, will be described. FIG. 13 is an explanatory view illustrating an optical path when external light L′ such as sunlight is incident on the screen member 15 from the windshield 401 via the projection minor 511 constituting the projection optical system. In the present embodiment, external light L′ such as sunlight, streetlight, or the like may be transmitted through the windshield 401, to be incident on the projection minor 511 of the head-up display device 500. At this time, the light may be reflected on the projection minor 511 to reach the screen member 15, to be reflected on the image light emitting surface of the screen member 15, and to return to the projection minor 511. When the external light L′ returned from the image light emitting surface of the screen member 15 to the projection mirror 511 in this way is reflected on the projection minor 511, the external light L′ may travel toward the windshield 401 along the same optical path as the image light L, and then, together with the image light L, may be reflected on the windshield 401 to travel toward the viewpoint area (the so-called eye range) 402a of the observer (driver 402) as the user. In this case, the external light L′ is superimposed on the virtual image G, to enter the eyes of the driver 402 who is visually recognizing the virtual image G by the image light, which reduces the visibility of the virtual image G.

Thereupon, in the present embodiment, as illustrated in FIG. 13, the image light emitting surface of the screen member 15 is disposed to be inclined with respect to the optical axis L0 of the image light so that even when the external light L′ incident on the projection minor 511 is incident on and reflected on the image light emitting surface of the screen member 15, and the flux of light traveling along the optical axis of the external light L′ travels toward the windshield 401 and is reflected on the windshield 401, the external light L′ is turned aside from the eye range 402a. Specifically, defining an angle of inclination θ as an angle formed between a plane S1 orthogonal to the optical axis L0 of the image light emitted from the image light emitting surface of the screen member 15, and a plane S2 parallel to the image light emitting surface of the screen member 15, the image light emitting surface of the screen member 15 is disposed to be inclined with respect to the optical axis L0 of the image light within a range of 0°<θ<90° so that the flux of light traveling along the optical axis of the external light L′ reflected on the image light emitting surface is turned aside from the eye range 402a.

Consider a case where the image light emitting surface of the screen member 15 is disposed so as to be orthogonal to the optical axis L0 of the image light, namely, a case where the angle of inclination θ is zero. In this case, for example, when the external light L′ is incident on the projection mirror 511 from the windshield 401 along the optical axis of the image light traveling from the projection mirror 511 to the windshield 401, the external light L′ is orthogonally incident on the image light emitting surface of the screen member 15 along the optical axis L0 of the image light. In this case, the external light L′ reflected on the image light emitting surface of the screen member 15 travels along the optical axis L0 of the image light as it is, follows the same optical path as the image light to travel toward the so-called eye range 402a, to reduce the visibility of the virtual image G.

In contrast, in the present embodiment, when the external light L′ is incident on the projection mirror 511 from the windshield 401 along the optical axis of the image light traveling from the projection mirror 511 toward the windshield 401, the external light L′ is obliquely incident on the image light emitting surface of the screen member 15. Therefore, the external light L′ reflected on the image light emitting surface of the screen member 15 is reflected in a direction different from the optical axis L0 of the image light, to follow an optical path different from that of the image light. Then, the external light L′ reflected on the image light emitting surface of the screen member 15 is reflected on the projection mirror 511 to travel toward the windshield 401, and even if reflected on the windshield 401, is turned aside from the eye range 402a.

Further, in the present embodiment, a flux of light incident on the projection mirror 511; reflected on the image light emitting surface of the screen member 15; and traveling along the optical axis of the external light L′, constitutes a part having the greatest amount of light in the external light L′ reflected on the image light emitting surface of the screen member 15. Therefore, turning the flux aside from the eye range 402 enables to curb the amount of light of the external light L′ traveling toward the eye range 402a.

In the present embodiment, the angle range of the angle of inclination θ representing the angle of inclination between the image light emitting surface of the screen member 15 and the optical axis L0 of the image light can be defined by the following expression (1). In other words, setting the angle of inclination θ within the range satisfying the following expression (1), enables to turn the external light L′ reflected on the image light emitting surface of the screen member 15 aside from the eye range 402a.

$$\begin{matrix}[ Math . 1 ] & \\ θ = \frac{1}{2} {tan}^{- 1} ( \frac{{Y}_{er}}{2 l} ) & ( 1 )\end{matrix}$$

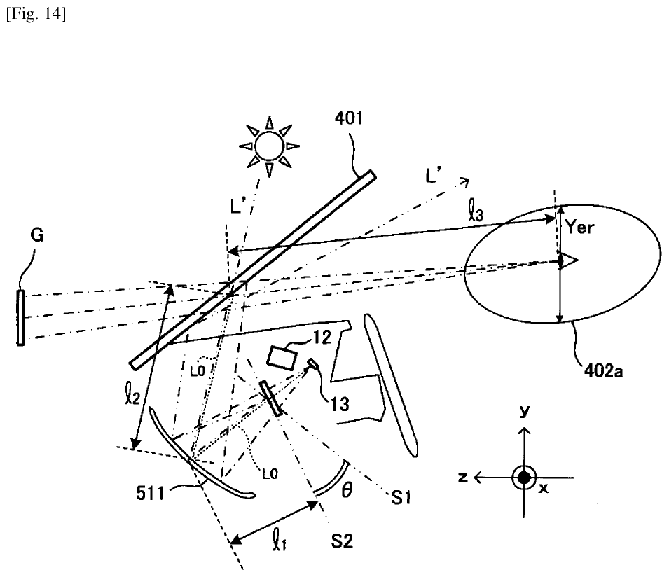

In the expression (1), “1” represents the optical path length of a flux of light traveling along the optical axis of the image light emitted from the image light emitting surface of the screen member 15 when the flux reaches the center position of the eye range 402a. As illustrated in FIG. 14, this optical path length l of the flux of light traveling along the optical axis of the image light emitted from the image light emitting surface of the screen member 15 is the total of an optical path length l₁ from the image light emitting surface of the screen member 15 to the projection mirror 511; an optical path length l₂ from the projection mirror 511 to the windshield 401; and an optical path length l₃ from the windshield 401 to the center position of the eye range 402a. Also, in the equation (1), “Yₑᵣ” represents a length of the eye range 402a in a direction in which the external light L′ is turned aside from the center position of the eye range 402a by the image light emitting surface of the screen member 15 inclined with respect to the optical axis L0 of the image light; this corresponds to, in the present embodiment, the perpendicular length of the eye range 402a or the length of the eye range 402a in the sub-scanning direction of the virtual image G.

Here, when the image light emitting surface of the screen member 15 is inclined with respect to the optical axis L0 of the image light, the focal position may be shifted at a peripheral portion of an image, which may lower a resolution characteristic of the virtual image G (characteristic representing sharpness of the image). Thereupon, in the present embodiment, it is favorable that the angle range of the angle of inclination θ representing the angle of inclination between the image light emitting surface of the screen member 15 and the optical axis L0 of the image light, is set within a range where the resolution characteristic of the virtual image G can be contained within an allowable range.

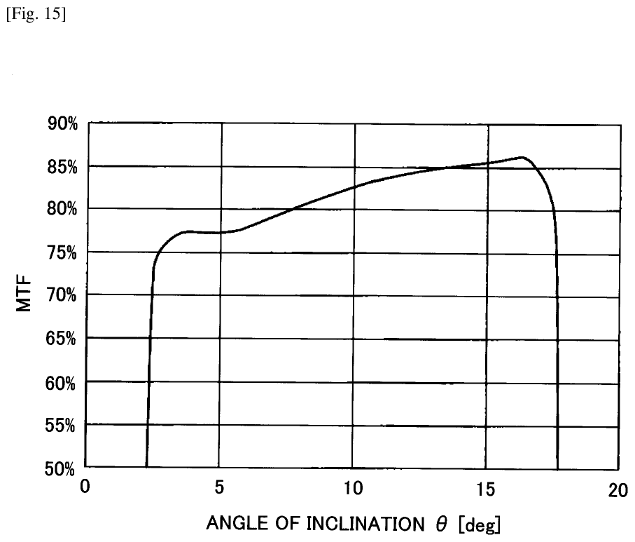

FIG. 15 is a graph illustrating a relationship between the MTF (Modulation Transfer Function) value serving as an index value of the resolution characteristic, and the angle of inclination θ representing the angle of inclination between the image light emitting surface of the screen member 15 and the optical axis L0 of the image light. The MTF value is an MTF value at 10 cpd (cycles/degree), which takes a value closer to 100% when the resolution characteristic is better; if the MTF value is greater than or equal to 75%, a resolution characteristic within an allowable range can be obtained, and a value greater than or equal to 80% is favorable. As illustrated in FIG. 15, in the present embodiment, even when the image light emitting surface of the screen member 15 is inclined with respect to the optical axis L0 of the image light, as long as the angle of inclination θ is within the range of 3° to 17°, the MTF value is greater than or equal to 75%, and a resolution characteristic within an allowable range can be obtained. Also, if the angle of inclination θ is in the range of 8° to 17°, even when the image light emitting surface of the screen member 15 is inclined with respect to the optical axis L0 of the image light, the MTF value is greater than or equal to 80%, and a satisfactory resolution characteristic can be maintained.

As above, the embodiments of the present invention have been described; note that the embodiments described above simply show application examples of the present invention. The present invention is not limited to the embodiments described above as they are, and may be embodied by adding various modifications and changes when being implemented without departing from the gist thereof.

For example, in the present embodiment, the screen member 15 has a configuration in which a microlens array having microlenses two-dimensionally arranged for diffusing incident image light is provided on the side of the image light emitting surface, this microlens array may be provided on the side of the image light incident surface, or may be provided on both sides of the image light incident surface and the image emitting surface. However, the configuration that provides the microlens array on the image light emitting surface side enables to diffuse the reflected light when the external light L′ incident from the projection mirror 511 side is reflected on the image light emitting surface of the screen member 15; therefore, the amount of light reaching the eye range 402a in the reflected external light L′ is further reduced, which enables to further prevent the reduction of the image visibility due to external light.

Also, forming the image light emitting surface of the screen member 15 to have a convex curved surface shape, the curvature of field can be reduced. Further, this enables to diffuse the reflected light when the external light L′ incident from the projection mirror 511 side is reflected on the image light emitting surface of the screen member 15; therefore, the amount of light reaching the eye range 402a in the reflected external light L′ is further reduced, which enables to further prevent the reduction of the image visibility due to the external light. In particular, if the image light emitting surface is curved only in one of the main scanning direction and the sub scanning direction like a cylindrical lens, it is favorable to curve the image light emitting surface only in the direction in which the curvature of field tends to occur.

Also, by forming the image light emitting surface of the screen member 15 to have a convex curved surface shape and by forming the image light incident surface of the screen member 15 to have a concave curved surface shape to obtain a toroidal screen member 15, it is possible to reduce the curvature of field both in the main scanning directions and in the sub-scanning direction. Alternatively, the screen member 15 may be formed such that the image light emitting surface of the screen member 15 has a convex curved surface shape, and the image light incident surface of the screen member 15 also has a convex curved surface shape. Also in this case, it is possible to reduce the curvature of field both in the main scanning directions and in the subscanning direction.

Also, by forming the image light emitting surface of the screen member 15 to have a free-form surface shape, it is possible to reduce the curvature of field over the entire virtual image G.

The above description merely shows examples, and each of the following aspects brings specific effects.

<First Aspect>

A first aspect is characterized by an image projection device (e.g., a head-up display device 500) that projects an image (e.g., an intermediate image) formed on an image forming member (e.g., a screen member 15) by a projection optical system (e.g., a projection mirror 511), in which an image light emitting surface of the image forming member is disposed to be inclined with respect to an optical axis L0 of image light so that when external light L′ incident on the projection optical system is incident on the image light emitting surface of the image forming member, a flux of light traveling along an optical axis of the external light reflected on the image light emitting surface is turned aside from a viewpoint area (e.g., an eye range 402a) of a user.

According to this aspect, by disposing the image light emitting surface of the image forming member to be inclined with respect to the optical axis of the image light, even when external light incident on the projection optical system is incident on the image light emitting surface of the image forming member, and reflected on the image light emitting surface, light traveling along the optical axis of the reflected external light is turned aside from the viewpoint area of the user. This enables to curve the amount of light traveling toward the viewpoint area of the user in the external light incident on the image forming member from the projection optical system. Therefore, it is possible to prevent reduction of the visibility of the image visually recognized by the user due to the external light. Note that the viewpoint area of the user is normally a predetermined area in which the position of the eye of the user is distributed, for example, the eye range 402a of the driver of a motor vehicle or the like.

<Second Aspect>

A second aspect is characterized by the image projection device as described in the first aspect, in which the image light emitting surface of the image forming member is disposed to be inclined with respect to the optical axis of the image light so that a MTF (Modulation Transfer Function) value at a specific spatial frequency (10 cpd) falls within a range greater than or equal to 75%.

According to this aspect, even when the image light emitting surface of the image forming member is arranged to be inclined with respect to the optical axis of the image light, the resolution characteristic of a virtual image G can be kept within an allowable range, and the sharpness of the image to be visually recognized the user can be secured.

<Third Aspect>

A third aspect is characterized by the image projection device as described in the first or second aspect, in which an angle between a plane orthogonal to the optical axis of the image light and the image light emitting surface (angle of inclination θ) falls within a range greater than or equal to 3° and less than or equal to 17°.

According to this aspect, even when the image light emitting surface of the image forming member is disposed to be inclined with respect to the optical axis of the image light, as long as the angle of inclination θ falls within this range, the resolution characteristic of a virtual image G can be kept within an allowable range, and the sharpness of the image to be visually recognized the user can be secured.

<Fourth Aspect>

A fourth aspect is characterized by the image projection device as described in any one of the first to third aspects, in which the image forming member includes a microlens array in which microlenses for diffusing incident image light are two-dimensionally arranged on a side of the image light emitting surface.

According to this aspect, it is possible to diffuse the reflected light by the microlens when the incident external light is reflected on the image light emitting surface of the image forming member. Therefore, the amount of light reaching the viewpoint area of the user in the reflected external light is further reduced, and it is possible to further prevent reduction of the image visibility due to external light.

<Fifth Aspect>

A fifth aspect is characterized by the image projection device as described in any one of the first to fourth aspects, in which the image forming member includes a microlens array in which microlenses for diffusing incident image light are two-dimensionally arranged on a side of the image light incident surface.

According to this aspect, since the divergence profile of the image light emitted from the image light emitting surface of the image forming member becomes closer to a rectangular shape than in the case where the microlens array is provided on the side of the image light emitting surface of the image forming member, difference in the brightness can be reduced more easily.

<Sixth Aspect>

A sixth aspect is characterized by the image projection device as described in any one of the first to fifth aspects, in which the image forming member has the image light emitting surface having a convex curved surface shape.

According to this aspect, the curvature of field can be reduced. Moreover, it is possible to diffuse the reflected light when the incident external light is reflected on the image light emitting surface of the image forming member. Therefore, the amount of light reaching the viewpoint area of the user in the reflected external light is further reduced, and it is possible to further prevent reduction of the image visibility due to external light.

<Seventh Aspect>

A seventh aspect is characterized by the image projection device as described in the sixth aspect, in which the image forming member has an image light incident surface having a concave curved surface shape.

According to this aspect, the curvature of field can be reduced both in the main scanning direction and in the sub-scanning direction.

<Eighth Aspect>

An eighth aspect is characterized by the image projection device as described in the sixth aspect, in which the image forming member has an image light incident surface having a convex curved surface shape.

According to this aspect, the curvature of field can be reduced both in the main scanning direction and in the sub-scanning direction.

<Ninth Aspect>

A ninth aspect is characterized by the image projection device as described in any one of the sixth to eighth aspects, in which the image forming member has the image light emitting surface having a free-form curved surface shape.

According to this aspect, the curvature of field can be reduced over the entire virtual image G.

<Tenth Aspect>

A tenth aspect is characterized by a mobile body (e.g., a motor vehicle 400) including the image projection device as described in any one of the first to ninth aspects.

According to this aspect, it is possible to realize a mobile body in which reduction of the visibility of an image visually recognized by the user due to external light can be prevented.

### CITATION LIST

### Patent Literature

[PTL 1] Japanese Patent No. 4325724

The present application is based on and claims the benefit of priority of Japanese Priority Application No. 2018-051221 filed on Mar. 19, 2018, with the Japanese Patent Office, the entire contents of which are hereby incorporated by reference.

1-10. (canceled)

11. An image projection device that projects an image formed on an image forming member by a projection optical system, wherein an image light emitting surface of the image forming member is disposed to be inclined with respect to an optical axis of image light so that when external light incident on the projection optical system is incident on the image light emitting surface of the image forming member, a flux of light traveling along an optical axis of the external light reflected on the image light emitting surface is turned aside from a viewpoint area of a user.

12. The image projection device as claimed in claim 11, wherein the image light emitting surface of the image forming member is disposed to be inclined with respect to the optical axis of the image light so that a MTF (Modulation Transfer Function) value at a specific spatial frequency falls within a range greater than or equal to 75%.

13. The image projection device as claimed in claim 11, wherein an angle between a plane orthogonal to the optical axis of the image light and the image light emitting surface falls within a range greater than or equal to 3° and less than or equal to 17°.

14. The image projection device as claimed in claim 11, wherein the image forming member includes a microlens array in which microlenses for diffusing incident image light are two-dimensionally arranged on a side of the image light emitting surface.

15. The image projection device as claimed in claim 11, wherein the image forming member includes a microlens array in which microlenses for diffusing incident image light are two-dimensionally arranged on a side of the image light incident surface.

16. The image projection device as claimed in claim 11, wherein the image forming member has the image light emitting surface having a convex curved surface shape.

17. The image projection device as claimed in claim 16, wherein the image forming member has an image light incident surface having a concave curved surface shape.

18. The image projection device as claimed in claim 16, wherein the image forming member has an image light incident surface having a convex curved surface shape.

19. The image projection device as claimed in claim 16, wherein the image forming member has the image light emitting surface having a free-form curved surface shape.

20. A mobile body comprising:
the image projection device as claimed in claim 11.
